(19) United States
(12) Patent Application Publication
(10) Pub. No.: US 2007/0200384 A1
(43) Pub. Date: Aug. 30, 2007

(54) Motor vehicle comprising at least one row of seats

(75) Inventors: Stefan Schwingenschloegel, Muenchen (DE); Kai Burghard, Muenchen (DE); Christian Goerg, Schwabhausen (DE); Karol Virsik, Muenchen (DE); Maximilian Reitmeir, Muenchen (DE); Axel-Artur Poweleit, Muenchen (DE); Rudolf Dirk, Nedved (DE)

Correspondence Address: CROWELL & MORING LLP;INTELLECTUAL PROPERTY GROUP, P.O. BOX 14300, WASHINGTON, DC, 20044-4300, US

(73) Assignee: Bayerische Motoren Werke Aktiengesellschaft, Muenchen (DE)

(21) Appl. No.: 11/648,633

(22) Filed: Jan. 3, 2007

Related U.S. Application Data
(63) Continuation of application No. PCT/EP05/06902, filed on Jun. 27, 2005.

(30) Foreign Application Priority Data
Jul. 30, 2004 (DE) 10 2004 032 244.9

(51) Int. Cl. B60N 2/00

(52) U.S. Cl. 296/64; 296/65.02; 296/65.05

(57) ABSTRACT

A motor vehicle including at least one row of seats consisting of a continuous full width seat and a split back rest is provided. The motor vehicle provides a comfortable seat in the middle of a third row of seats, so that even tall people have sufficient room. To this end, a central region of the full width seat can be lowered.

### CROSS REFERENCE TO RELATED APPLICATIONS

This application is a continuation of PCT International Application No. PCT/EP2005/006902, filed Jun. 27, 2005, which claims priority under 35 U.S.C. § 119 to German Patent Application No. 10 2004 032 244.9 filed Jul. 3, 2004, the entire disclosures of which are herein expressly incorporated by reference.

### BACKGROUND AND SUMMARY OF THE INVENTION

The present invention relates to a motor vehicle including at least one row of seats, which includes a continuous full-width seat and a split backrest.

Multi-functional vehicles, like minivans, SUV's or MPV's, often have a variable seat concept and exhibit a third row of seats including two seats. These seats generally offer two persons very limited room. Usually only children or the like may sit comfortably in those seats. In addition, the spatial perception in the third row of seats is very limited, because the second row of seats acts as a wall in front of the persons in the third row of seats.

Therefore, the object of the present invention is to create a motor vehicle providing a comfortable seat in the middle of the third row of seats so that even tall people have sufficient room.

The motor vehicle, designed according to the invention, has the advantage that by lowering the central region of the full-width seat, the comfort for the middle seat is raised and simultaneously the H-point may be lowered by means of static compression. This increases the head room and simultaneously creates more room for tall people. A motor vehicle that is equipped in such a manner offers not only two conventional seats with limited room, but also a comfortable seat in the middle of the full-width seat.

Owing to these features, advantageous further developments of the motor vehicle are possible.

The inventive configuration can be employed in an especially meaningful manner, if the row of seats is a third row of seats offering limited room. A motor vehicle with this row of seats may be used not only as a “seven seater,” but also offers five very comfortable seats. The middle seat in the third row of seats offers significantly more room and also more comfort (among other things, shoulder room) than a third seat between the outermost seats in the second row of seats.

The option of lowering the central region of the full-width seat is achieved according to an advantageous further development, in that the central region of the full-width seat may be elastically deflected.

This deflection is designed in a lockable manner, according to an exemplary embodiment, so that in the event that the full-width seat is used by two persons, these persons do not tilt toward the middle.

The full-width seat may be moved advantageously in the longitudinal direction of the vehicle. In addition, the angle of tilt of the backrest can also be adjusted. Due to these features, the sitting comfort can be improved.

According to another exemplary embodiment, the second row of seats may be folded away toward the front of the vehicle to create sufficient leg room for the middle seat. This creates an improved perception of space, because the person in the middle seat in the third row of seats no longer has a seat in front of him; and an unobstructed view toward the front is possible.

Other objects, advantages and novel features of the present invention will become apparent from the following detailed description of the invention when considered in conjunction with the accompanying drawings.

### BRIEF DESCRIPTION OF THE DRAWING FIGURES

FIG. 1 is a top view of a motor vehicle equipped according to the invention, with a row of seats for use by two persons.

FIG. 2 is a top view of a motor vehicle equipped according to the invention, with a row of seats, in which the central region is lowered; and

FIG. 3 is a top view of a motor vehicle equipped according to the invention with a row of seats and a person sitting in the central region.

### DETAILED DESCRIPTION OF THE DRAWINGS

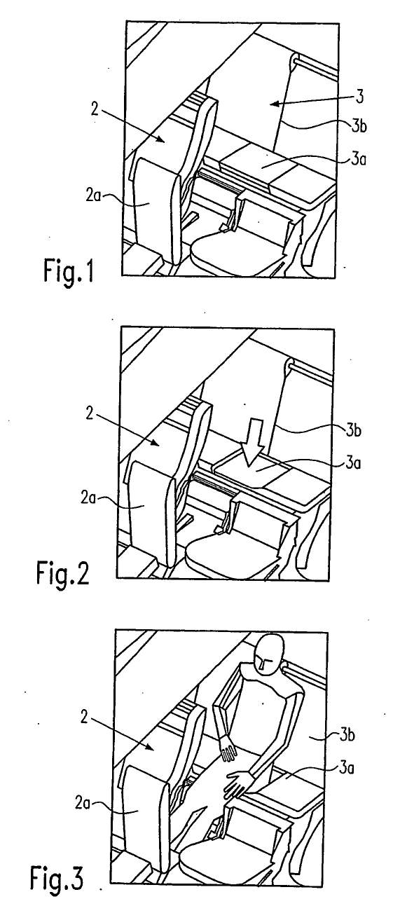

FIGS. 1 to 3 are top views of a motor vehicle, depicting a second row of seats 2 and a third row of seats 3. A backrest of the second row of seats 2 is partially cut away in order to expose the third row of seats 3. In the drawings, according to FIGS. 1 to 3, the middle seat 2a in the second of row of seats 2 is folded toward the front in order to provide more leg room for the person sitting in the middle of the third row of seats 3.

The third row of seats 3 includes a continuous full-width seat 3a and a split backrest 3b. The full-width seat 3a may be moved in the longitudinal direction of the vehicle; and the angle of tilt of the backrest 3b can be adjusted.

The central region of the full-width seat 3a of the third row of seats 3 can be lowered, for example, by 30 to 40 mm. This state is shown in FIG. 2. To achieve this state, the central region of the full-width seat 3a exhibits a deflection that is lockable, in order to ensure sufficient sitting comfort even when used by two people.

As evident especially from FIG. 3, the person, sitting in the middle seat, also has sufficient leg room, a state that is achieved by folding over the middle seat 2a of the second row of seats 2.

The inventive configuration of the full-width seat 3a makes possible a number of different seat heights. There is also the possibility of setting various seat hardnesses.

The above description of the embodiment, according to the present invention, serves only for illustrative purposes and not for the purpose of restricting the invention. A number of different changes and modifications are possible within the scope of the invention without leaving the scope of the invention or its equivalent.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A motor vehicle comprising:
at least one row of seats comprising a continuous full-width seat and a split backrest;
wherein a central region of the full-width seat can be lowered.

2. The motor vehicle, as claimed in claim 1, wherein the at least one row of seats is a third row of seats having limited room for passengers.

3. The motor vehicle, as claimed in claim 1, wherein the central region of the full-width seat is elastically deflectable.

4. The motor vehicle, as claimed in claim 1, wherein the central region of the full-width seat is lockably deflectable.

5. The motor vehicle, as claimed in claim 1, wherein the full-width seat can be moved in the longitudinal direction of the motor vehicle.

6. The motor vehicle, as claimed in claim 1, wherein an angle of tilt of the backrest is adjustable.

7. The motor vehicle, as claimed in claim 1, wherein a second row of seats having a middle seat is located in front of the third row of seats and the middle seat can be folded away toward the front of the motor vehicle.

8. The motor vehicle, as claimed in claim 2, wherein the central region of the full-width seat is elastically deflectable.

9. The motor vehicle, as claimed in claim 2, wherein the central region of the full-width seat is lockably deflectable.

10. The motor vehicle, as claimed in claim 2, wherein the full-width seat can be moved in the longitudinal direction of the motor vehicle.

11. The motor vehicle, as claimed in claim 2, wherein an angle of tilt of the backrest is adjustable.

12. The motor vehicle, as claimed in claim 2, wherein a second row of seats having a middle seat is located in front of the third row of seats and the middle seat can be folded away toward the front of the motor vehicle.

13. The motor vehicle, as claimed in claim 3, wherein the central region of the full-width seat is lockably deflectable.

14. The motor vehicle, as claimed in claim 3, wherein the full-width seat can be moved in the longitudinal direction of the motor vehicle.

15. The motor vehicle, as claimed in claim 3, wherein an angle of tilt of the backrest is adjustable.

16. The motor vehicle, as claimed in claim 3, wherein a second row of seats having a middle seat is located in front of the third row of seats and the middle seat can be folded away toward the front of the motor vehicle.

17. The motor vehicle, as claimed in claim 4, wherein an angle of tilt of the backrest is adjustable.

18. The motor vehicle, as claimed in claim 4, wherein a second row of seats having a middle seat is located in front of the third row of seats and the middle seat can be folded away toward the front of the motor vehicle.

19. The motor vehicle, as claimed in claim 5, wherein an angle of tilt of the backrest is adjustable.

20. The motor vehicle, as claimed in claim 5, wherein a second row of seats having a middle seat is located in front of the third row of seats and the middle seat can be folded away toward the front of the motor vehicle.
